(19) United States
(12) Patent Application Publication
(10) Pub. No.: US 2025/0291560 A1
(43) Pub. Date: Sep. 18, 2025

(54) INFORMATION PROCESSING APPARATUS, APPLICATION EDITING SYSTEM, AND INFORMATION PROCESSING METHOD

(71) Applicant: Seiichi KONDO, Tokyo (JP)

(72) Inventor: Seiichi KONDO, Tokyo (JP)

(21) Appl. No.: 19/070,536

(22) Filed: Mar. 5, 2025

(30) Foreign Application Priority Data
Mar. 18, 2024 (JP) 2024-042902

(51) Int. Cl. G06F 8/35; G06F 9/451; H04L 51/02

(52) U.S. Cl. CPC G06F 8/35; G06F 9/452; H04L 51/02

(57) ABSTRACT

An information processing apparatus communicably connected with a terminal apparatus and a generative artificial intelligence (AI) system via a network includes processing circuitry. The processing circuitry receives an acquisition request for acquiring screen information of an editing screen of an application. The processing circuitry transmits, to the terminal apparatus, the screen information including a program for editing the application in response to a response message from the generative AI system. In response to receiving a chat message from the terminal apparatus, the processing circuitry transmits the chat message, information on the application specified by the identification information, and information used for calling a function defining the editing content to the generative AI system, receives a response message including the call of the function defining the editing content from the generative AI system, transmits the response message; and causes the terminal apparatus to execute an editing process based on the function.

### CROSS-REFERENCE TO RELATED APPLICATIONS

This patent application is based on and claims priority pursuant to 35 U.S.C. § 119 (a) to Japanese Patent Application No. 2024-042902, filed on Mar. 18, 2024, in the Japan Patent Office, the entire disclosure of which is hereby incorporated by reference herein.

### BACKGROUND

### Technical Field

The present disclosure relates to an information processing apparatus, an application editing system, and an information processing method.

### Related Art

A Technique for supporting programming has been proposed in which the input of program code is reduced or eliminated, for example, using artificial intelligence (AI) to automatically generate a program code.

### SUMMARY

Embodiments of the present disclosure described herein provide a novel information processing apparatus communicably connected with a terminal apparatus and a generative artificial intelligence (AI) system via a network. The information processing apparatus includes processing circuitry. The processing circuitry receives, from the terminal apparatus, an acquisition request for acquiring screen information of an editing screen of an application, the acquisition request including identification information of the application. The processing circuitry transmits, to the terminal apparatus, the screen information including a program for editing the application in response to a response message from the generative AI system. In response to receiving, from the terminal apparatus, a chat message including an editing content input to the editing screen displayed on the terminal apparatus based on the screen information, the processing circuitry transmits to the generative AI system the chat message, information on the application specified by the identification information, and information used for calling a function defining the editing content. The processing circuitry receives a response message including the call of the function defining the editing content from the generative AI system. The processing circuitry transmits the response message including the call of the function defining the editing content to the terminal apparatus. The processing circuitry causes the terminal apparatus to execute an editing process based on the function defining the editing content.

Embodiments of the present disclosure described herein provide a novel application editing system includes a terminal apparatus, a generative AI system, and an information processing apparatus communicably connected with the terminal apparatus and the generative AI system via a network. The information processing apparatus includes processing circuitry. The processing circuitry receives, from the terminal apparatus, an acquisition request for acquiring screen information of an editing screen of an application, the acquisition request including identification information of the application. The processing circuitry transmits, to the terminal apparatus, the screen information including a program for editing the application in response to a response message from the generative AI system. In response to receiving, from the terminal apparatus, a chat message including an editing content input to the editing screen displayed on the terminal apparatus based on the screen information, the processing circuitry transmits to the generative AI system the chat message, information on the application specified by the identification information, and information used for calling a function defining the editing content. The processing circuitry receives a response message including the call of the function defining the editing content from the generative AI system. The processing circuitry transmits the response message including the call of the function defining the editing content to the terminal apparatus. The terminal apparatus includes terminal circuitry. The terminal circuitry executes a web browser. When the response message from the generative AI system includes a request to call the function defining the editing content, the web browser executes the program for editing the application.

Embodiments of the present disclosure described herein provide a novel information processing method, executed by an information processing apparatus communicably connected with a terminal apparatus and a generative AI system via a network. The method includes: receiving, from the terminal apparatus, an acquisition request for acquiring screen information of an editing screen of the application, the acquisition request including identification information of the application; transmitting, to the terminal apparatus, the screen information including a program for editing the application in response to a response message from the generative AI system; in response to receiving, from the terminal apparatus, a chat message including an editing content input to the editing screen displayed on the terminal apparatus based on the screen information, transmitting to the generative AI system the chat message, information on the application specified by the identification information, and information used for calling a function defining the editing content; receiving a response message including the call of the function defining the editing content from the generative AI system; transmitting the response message received from the generative AI system to the terminal apparatus, the response message including the call of the function defining the editing content; and causing the terminal apparatus to execute an editing process based on the function defining the editing content.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a system configuration of an application editing system according to a first embodiment of the present disclosure;

FIG. 2 is a diagram illustrating an outline of an operation of an application editing system;

FIG. 3 is a diagram illustrating a hardware configuration of an information processing system, a user terminal, and a developer terminal;

FIG. 4 is a diagram illustrating functions of an information processing system, a user terminal, and a developer terminal included in an application editing system according to the first embodiment of the present disclosure;

FIG. 5 is a sequence diagram illustrating an operation of an application editing system according to the first embodiment of the present disclosure;

FIG. 6 is a diagram illustrating functions of an information processing system, a user terminal, and a developer terminal included in an application editing system according to a second embodiment of the present disclosure;

FIG. 7 is a sequence diagram illustrating an operation of an application editing system according to the second embodiment of the present disclosure;

FIG. 8 is a first diagram illustrating a display of a user terminal;

FIG. 9 is a second diagram illustrating a display of a user terminal;

FIG. 10 is a third diagram illustrating a display of a user terminal;

FIG. 11 is a fourth diagram illustrating a display of a user terminal;

FIG. 12 is a fifth diagram illustrating a display of a user terminal;

FIG. 13 is a diagram illustrating information about an application to be edited;

FIG. 14 is a diagram illustrating a request message transmitted from an information processing system to a generative artificial intelligence (AI) system;

FIG. 15 is a first diagram of a response message illustrating a response message from a generative AI system;

FIG. 16 is a second diagram of response message of response message illustrating a response message from a generative AI system;

FIG. 17 is a sixth diagram illustrating a display of a user terminal;

FIG. 18 is a diagram illustrating a request message transmitted from a web browser to an application service;

FIG. 19 is a seventh diagram illustrating a display of a user terminal; and

FIG. 20 is a diagram illustrating another request message transmitted from an information processing system to a generative AI system.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

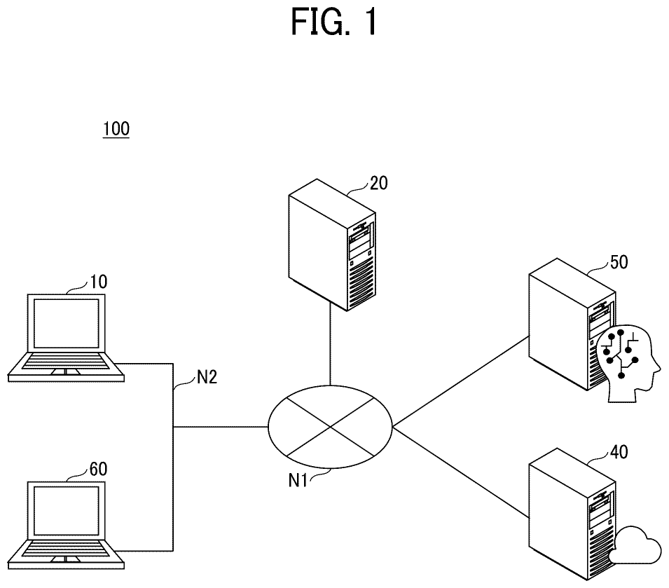

A description is given below of a first embodiment of the present disclosure with reference to the drawings. FIG. 1 is a diagram illustrating a system configuration of an application editing system 100 according to the first embodiment of the present disclosure.

The application editing system 100 according to the present embodiment includes an information processing system 20, a user terminal 10, and a developer terminal 60.

In the application editing system 100, the information processing system 20 and the user terminal 10, and the information processing system 20 and the developer terminal 60 are connected to communicate with each other via networks N1 and N2. The information processing system 20 can communicate with the generative artificial intelligence (AI) system 50 via the network N1. The user terminal 10 and the developer terminal 60 can communicate with the generative AI system 50 and the application service 40, which is an external system, via the networks N1 and N2. The information processing system 20 may communicate with the application service 40 via the network N1.

In the present embodiment, the network N1 is a wide area network such as the Internet or a wide area network (WAN), and the network N2 may be a cellular phone network such as a local area network (LAN), a Wi-Fi®, a wide area Ethernet®, 4G, 5G, or 6G.

The user terminal 10 is a terminal apparatus such as a personal computer (PC), a smartphone, or a tablet terminal mainly used by a user who uses a service provided by the application service 40. The developer terminal 60 is a terminal apparatus mainly used by a developer of the information processing system 20.

The user terminal 10 and the developer terminal 60 are installed in a facility such as a facility of company and a facility of home, and are connected to the network N2. The user terminal 10 and the developer terminal 60 may not be constantly connected to the network N2, and are connected to the network N2 when the information processing system 20, the generative AI system 50, or the application service 40 is used. In the user terminal 10 or the developer terminal 60, a web browser or a native application operates. The user terminal 10 or the developer terminal 60 can use various services provided by the information processing system 20, the generative AI system 50, or the application service 40.

The user terminal 10 receives a chat message from the user for editing an application provided by the application service 40. The developer terminal 60 is operated by the developer to generate setting information related to the application. The setting information is stored in the information processing system 20. Details of the setting information are described later.

The application service 40 is one or more information processing apparatuses that provide an application to be executed by the user. The application provided by the application service 40 is, for example, a database type web application that manages data in a table format. The user can set any fields of the application and can customize the application so that the user can store, read, or process data related to the customer's business. Editing of the application is performed by a user to add or delete a desired field, change the name of the desired field, or change the number of characters of the desired field in the database prepared in advance. In the following description, the application may be simply referred to as an app. In the following description, addition and deletion of the field, change of the name of the field, and change of the number of characters of the field may be referred to as the content of editing.

The application service 40 is, for example, a cloud service, an application service provider (ASP), and a software as a service (SaaS), and may include various services provided via a network. The services provided via a network are, for example, a database provision service and a storage service. The application service 40 may reside on the Internet. Alternatively, the application service 40 may reside in an on-premises environment.

The generative AI system 50 provides a service for the user to have conversations with an AI. As a system such as the generative AI system 50, a system using large language models (LLMs) has been proposed. The LLMs are models for natural language processing that have been trained using a large amount of text data.

The generative AI system 50 captures a huge amount of text in advance and learns knowledge from the text using deep learning or reinforcement learning. The generative AI system 50 uses this knowledge to provide a reply message to a chat message.

An interface with which the user inputs a chat message to the generative AI system 50 is referred to as a prompt. A chat message such as an instruction or a question is input to the prompt. The chat message may be a conversational sentence or a word composed of a natural language spoken by a human. An image may also be the chat message. The generative AI system 50 that generates a sentence for a chat message may be referred to as a generative AI.

The generative AI system 50 is characterized in that the generative AI system 50 can proceed with a conversation in a natural flow, the generative AI system 50 can expand ideas even in a field in which the user does not have knowledge to propose, and the generative AI system 50 can output accurate program codes.

In the present embodiment, the information processing system 20 can use the generative AI system 50 having such a feature to perform a conversation with the user in a natural flow.

In the present embodiment, as the generative AI system 50, a system using LLM such as generative pre-trained transformer-3 (GPT-3®), GPT-4®, Transformer®, or bidirectional encoder representations from Transformers (BERT®) has been proposed. The application editing system 100 according to the present embodiment can use ChatGPT using GPT-3 or GPT-4. Alternatively, the application editing system 100 according to the present embodiment may use a system using another LLM.

When the information processing system 20 according to the present embodiment receives an operation to start editing an application from the user terminal 10, the information processing system 20 outputs a program for executing an application editing process to the user terminal 10.

More specifically, when an application to be edited is selected on the user terminal 10, the information processing system 20 outputs the program for executing the application editing process to the user terminal 10. In the following description, a program for executing the editing process of the application may be referred to as an editing process program. The application to be edited is one of the applications managed by the application service 40.

In the present embodiment, when the information processing system 20 receives a chat message related to the editing content from the user terminal 10, the information processing system 20 includes the chat message in a request message and transmits the request message to the generative AI system 50. When the information processing system 20 receives a response message from the generative AI system 50, the information processing system 20 transmits the response message to the user terminal 10.

When the user terminal 10 receives the response message, the user terminal 10 uses the editing process program output from the information processing system 20 to perform an editing process corresponding to the response message on the application to be edited.

As described above, in the present embodiment, the user can select the application to be edited and input the chat message in the user terminal 10 to edit the application of the application service 40 with no-code. In other words, in the present embodiment, the user can only select an application to be edited and input a chat message instructing desired editing to receive a proposal of specific editing content.

In FIG. 1, the application service 40 and the information processing system 20 are provided separately, but the present invention is not limited to this, and the information processing system 20 and the application service 40 may be integrated. In other words, the application service 40 may include the functions of the information processing system 20. Alternatively, the information processing system 20 may include the functions of the application service 40. The application service 40 may be integral with the generative AI system 50. The generative AI system 50 may be integral with the information processing system 20. The information processing system 20 may be integral with the application service 40 and the generative AI system 50.

The information processing system 20 may be implemented by cloud computing. Alternatively, the information processing system 20 may be implemented by a single information processing apparatus. The “cloud computing” refers to a usage pattern in which resources on a network are used or accessed without identifying specific hardware resources. The information processing system 20 may reside on the Internet. Alternatively, the information processing system 20 may reside in an on-premises environment.

The information processing system 20 may have its functions distributed across multiple information processing apparatuses. Alternatively, the information processing system 20 may have the multiple information processing systems 20 with the same functions, and the number of the information processing systems 20 may be increased or decreased depending on the processing load.

The user terminal 10 is, for example, a terminal apparatus such as a PC, a smartphone, or a tablet terminal mainly used by the user to whom a service is provided by the application service 40.

The user terminal 10 may be any information processing apparatus. Such an information processing apparatus includes an output apparatus such as an electronic whiteboard or a digital signage. Such an information processing apparatus also includes a head up display (HUD) apparatus, an industrial machine, an imaging apparatus, a sound collecting apparatus, a medical apparatus, a network home appliance, a mobile phone, a smartphone, a tablet terminal, a game machine, a personal digital assistant (PDA), a digital camera, and a wearable PC.

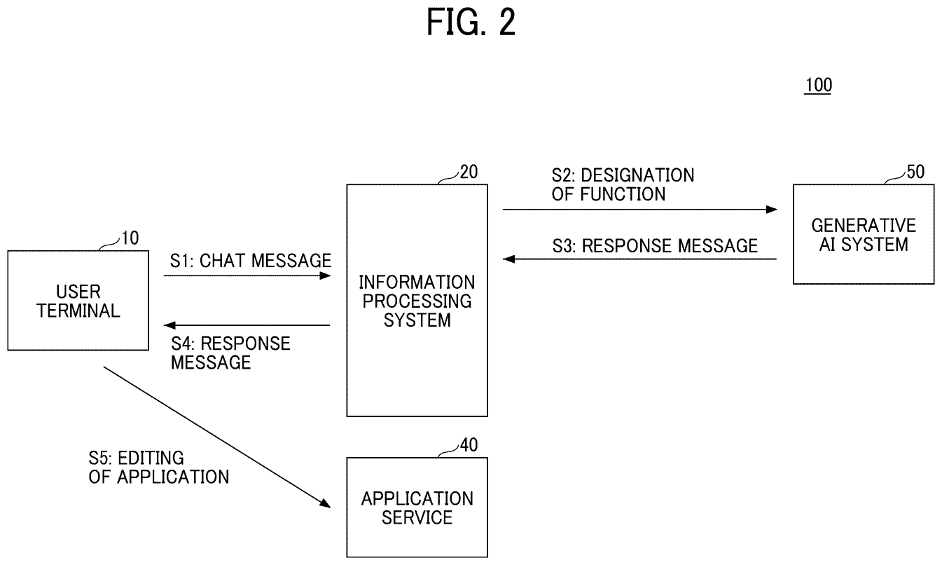

A description is given below of an outline of the operation of the application editing system 100 of the present embodiment with reference to FIG. 2. FIG. 2 is a diagram illustrating the outline of the operation of the application editing system 100.

In step S1, in the application editing system 100, the user terminal 10 transmit a chat message input by the user to the information processing system 20. In the present embodiment, the chat message may be a message indicating the editing content of the application, such as “add a field.” The chat message may include not only a message indicating specific editing content such as “add a field” but also a message indicating a desire such as “want to edit an application.”

In step S2, when the information processing system 20 receives the chat message input by the user, the information processing system 20 includes the received chat message in a request message and transmits the request message to the generative AI system 50. In this case, the information processing system 20 transmits the request message to the generative AI system 50 via the application programming interface (API) for receiving the request message provided by the generative AI system 50. The information processing system 20 transmits the request message including designation of a specification of a function.

The function is a program interface that performs a predetermined process with specified arguments and returns a return value as a result. This function is a function for enabling the generative AI system 50 to request the information processing system 20 to edit an application used on the application service 40. The information processing system 20 transmits the request message that includes the setting of the specification of the function to the generative AI system 50.

The generative AI system 50 requesting the information processing system 20 to call the function is referred to as a function call. The information processing system 20 can include information on the application to be edited in the request message.

The information on the application to be edited is information indicating a parameter managed by the application for which the user has requested editing. The parameter managed by the application include, for example, the field name, the number of fields, and the number of characters indicating the field name managed by the application.

The information processing system 20 may not include the information on the application to be edited and the setting of the function specification in the same request message as the received chat message. For example, the information processing system 20 may include information related to the application to be edited and the setting of the function specification in a request message different from the request message including the received chat message, and transmit the request message to the generative AI system 50.

The information processing system 20 may also include the information on the application to be edited and the setting of the function specification in different request messages to transmit the request messages to the generative AI system 50.

The information processing system 20 may transmit the information on the application to be edited and the setting of the function specification each time the information processing system 20 transmits the request message including the received chat message or may transmit the information and the setting of the function specification only once at the beginning.

In step S3, the generative AI system 50 transmits a response message including a function call request (function call) to the information processing system 20 based on the history of the conversation by the chat message, the setting of the function specification, and the information on the application to be edited included in the transmitted request message.

The generative AI system 50 only requests the information processing system 20 to call a function. In the following description, the response message from the generative AI system 50 may be referred to as a response from the generative AI system 50.

In step S4, the information processing system 20 transmits the response message received from the generative AI system 50 to the user terminal 10.

In step S5, when the user terminal 10 receives the response message, the user terminal 10 executes the function call indicated by the response message using the editing process program received from the information processing system 20, and edits the application managed by the application service 40.

As described above, in the present embodiment, the user of the user terminal 10 can edit the application with low-code or no-code.

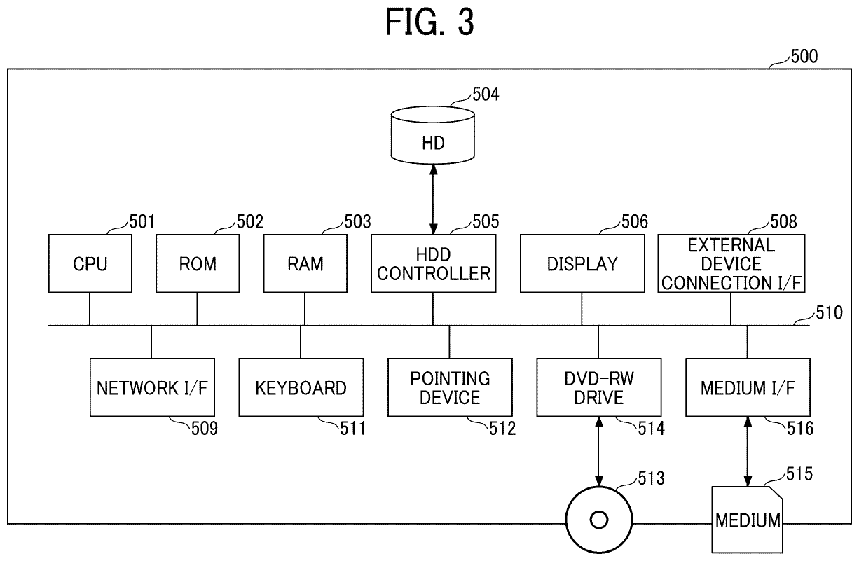

A description is given below of a hardware configuration of each device included in the application editing system 100 according to the present embodiment with reference to FIG. 3.

FIG. 3 is a diagram illustrating the hardware configuration of the information processing system 20, the user terminal 10, and a developer terminal 60. As illustrated in FIG. 3, the information processing system 20, the user terminal 10, and the developer terminal 60 each are implemented by a computer 500. The computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a medium I/F 516.

The CPU 501 controls the overall operation of the computer 500. The ROM 502 stores programs such as an initial program loader (IPL) to boot the CPU 501. The RAM 503 is used as a work area for the CPU 501. The HD 504 stores various data such as a program. The HDD controller 505 controls the reading and writing of various data from and to the HD 504 under the control of the CPU 501. The display 506 displays various information such as a cursor, a menu, a window, a character, or an image. The external device connection I/F 508 is an interface for connecting the computer 500 to various external devices. In this case, the external devices include, but not limited to, a universal serial bus (USB) memory and a printer. The network I/F 509 is an interface for performing data communication using the network N2. The bus line 510 is, for example, an address bus or a data bus, which electrically connects the components illustrated in FIG. 3, such as the CPU 501.

The keyboard 511 is an example of an input device (input means) including a plurality of keys used to input characters, numerals, or various instructions, for example. The pointing device 512 is an example of an input device that allows a user to select or execute various instructions, select an item to be processed, or move a cursor being displayed. The DVD-RW drive 514 controls the reading or writing of various data from and to a DVD-RW 513, which is an example of a removable storage medium. The DVD-RW is merely one example of the removable storage medium. In another example, the DVD-RW drive 514 controls the reading or writing of data from and to a digital versatile disk recordable (DVD-R). The medium I/F 516 controls the reading and writing (storing) of data from and to a storage medium 515 such as a flash memory.

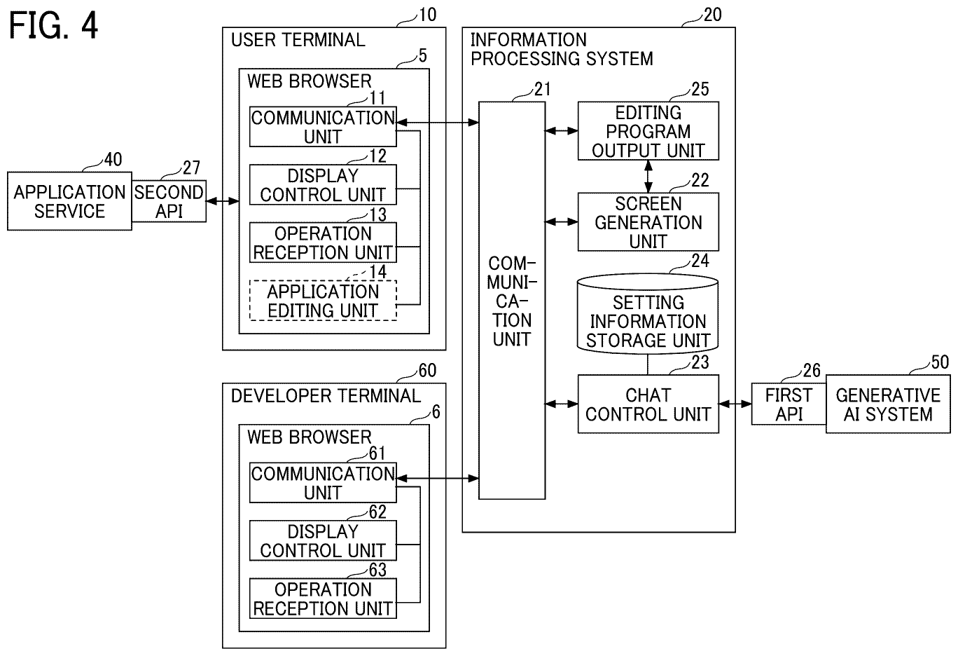

A description is given below of functions of the information processing system 20, the user terminal 10, and the developer terminal 60 included in the application editing system 100 according to the present embodiment with reference to FIG. 4. FIG. 4 is a diagram illustrating functions of the information processing system 20, the user terminal 10, and the developer terminal 60 included in the application editing system 100 according to the first embodiment of the present disclosure.

A description is given below of the functions of the information processing system 20. The information processing system 20 of the present embodiment includes a communication unit 21, a screen generation unit 22, a chat control unit 23, a setting information storage unit 24, and an editing program output unit 25. The functional units of the information processing system 20 are functions or means implemented by the CPU 501 illustrated in FIG. 3 executing commands included in one or more programs installed in the information processing system 20.

The setting information storage unit 24 is implemented in the HD 504 or the RAM 503 illustrated in FIG. 3. The setting information storage unit 24 may not be included in the information processing system 20, and may be provided on a network that can be accessed by the information processing system 20.

The communication unit 21 transmits and receives various kinds of information to and from the user terminal 10. The communication unit 21 transmits screen information of an application editing screen to the user terminal 10. The communication unit 21 receives a chat message input by the user to edit an application from the user terminal 10. The communication unit 21 transmits and receives various kinds of information to and from the developer terminal 60. The communication unit 21 transmits screen information of an input screen of setting information to the developer terminal 60. The communication unit 21 receives the setting information input by the developer from the developer terminal 60 and stores the setting information in the setting information storage unit 24. The communication unit 21 transmits a response message (response) received by the chat control unit 23 from the generative AI system 50 to the user terminal 10.

The screen generation unit 22 generates screen information of a screen (web page) displayed by the user terminal 10 and the developer terminal 60.

More specifically, the screen generation unit 22 generates screen information of an application editing screen displayed by the user terminal 10. The screen information of the application editing screen includes an editing process program for implementing an application editing unit 14 (described later) in the user terminal 10.

The web page is provided as a part of a web application. The screen information is a program written in, for example, hypertext markup language (HTML), JavaScript® object notation (JSON), extensible markup language (XML), a script language, and a cascading style sheet (CSS). The structure of the web page is specified by HTML, the operation of the web page is defined by the script language, and the style of the web page is specified by the CSS.

The chat control unit 23 calls a first API 26 to transmit a request message to the generative AI system 50. The request message includes a chat message (including a history of past conversations) and information defining a function.

The first API 26 is one or more APIs published by the generative AI system 50. As a result of calling the first API 26, the chat control unit 23 receives a response message to the request message from the generative AI system 50. The response message includes a reply message to the chat message, a function call request to the information processing system 20, or a uniform resource locator (URL) of a generated or developed application.

The setting information storage unit 24 stores the setting information. A description is given below of the setting information.

The setting information according to the present embodiment is information indicating knowledge necessary for editing the application of the application service 40. In other words, the setting information is information for the generative AI system 50 to edit the application, and includes a function that defines the editing process.

Specifically, the function that defines the editing process is a function that enables the generative AI system 50 to request the information processing system 20 to add a field in the application to be edited. The function that defines the editing process is a function that enables the generative AI system 50 to request the information processing system 20 to delete a field in the application to be edited. The function that defines the editing process is a function that enables the generative AI system 50 to request the information processing system 20 to update the application to be edited.

In the following description, the function that enables the generative AI system 50 to request the information processing system 20 to add a field of an application may be referred to as a field addition function. In the following description, the function that enables the generative AI system 50 to request the information processing system 20 to delete a field of an application may be referred to as a field deletion function. In the following description, the function that enables the generative AI system 50 to request the information processing system 20 to update an application may be referred to as an update function.

In the present embodiment, the developer stores the setting information in the setting information storage unit 24 before the user starts editing the application, and thus the user does not need to include the parameter of the application in the chat message.

The information processing system 20 generates a request message to be transmitted to the generative AI system 50 using the setting information. As described above, in the present embodiment, the developer stores the setting information in the information processing system 20, and thus the user can edit the application with a simple chat message even if the user does not have technical knowledge of the application.

The setting of the setting information is not constantly be needed, and the setting information may not be needed depending on the application.

When the communication unit 21 receives a request for acquiring screen information of an application editing screen for an application to be edited from the user terminal 10, the editing program output unit 25 outputs an editing process program for editing the application to be edited to the screen generation unit 22. The editing process program is written in JavaScript®. The editing process program is executed by the user terminal 10 to cause the user terminal 10 to execute editing process in accordance with the response message from the generative AI system 50.

A description is given below of the functions of the user terminal 10. The user terminal 10 according to the present embodiment includes a web browser 5. The web browser 5 includes a communication unit 11, a display control unit 12, and an operation reception unit 13. These functional units are functions or means that are implemented as the CPU 501 illustrated in FIG. 3 executes instructions included in one or more programs installed on the user terminal 10.

The communication unit 11, the display control unit 12, and the operation reception unit 13 may be implemented by a JavaScript® program.

The communication unit 11 transmits and receives various kinds of information to and from the information processing system 20. In the present embodiment, the communication unit 11 receives screen information of a portal screen from the application service 40, and receives screen information of the application editing screen on which a chat message is input from the information processing system 20. The communication unit 11 transmits a chat message and operation information on the user terminal 10 to the information processing system 20. The communication unit 11 may directly communicate with the generative AI system 50.

The display control unit 12 interprets screen information of various screens to display screens on the display 506. The operation reception unit 13 receives various operations of the user on the various screens displayed on the display 506.

The user terminal 10 of the present embodiment receives screen information of the editing screen including the editing process program from the information processing system 20.

The user terminal 10 receives the screen information of the editing screen and executes the editing process program to implement the function of the application editing unit 14. In other words, the web browser 5 of the user terminal 10 executes JavaScript® included in the screen information of the editing screen acquired from the information processing system 20, and thus the web browser 5 includes the application editing unit 14.

The application editing unit 14 calls a second API 27 to transmit a request message to the application service 40. The request message is a message for requesting editing of the application, and includes parameters (a field name of a database and a data format) related to the application and content of editing.

The second API 27 is one or more APIs published by the application service 40. As a result of calling the second API 27, the application editing unit 14 receives a response message to the request message from the application service 40. The response message includes a result (success or failure) of the request for editing the application. When the editing of the application is successful, the URL of the application is notified, and when the editing of the application is failure, an error message is notified. The result of the request for editing the application may be displayed by the display control unit 12.

Editing an application indicated that the application editing unit 14 requests the application service 40 to edit an application and the application service 40 actually edits the application.

The user terminal 10 may execute a native application. The native application is an application that cannot be executed unless the application is installed in the user terminal 10. In the case of the native application, the user terminal 10 includes the screen information of the editing screen, and the information to be displayed is transmitted in JSON or XML.

A description is given below of the function of the developer terminal 60. The developer terminal 60 includes a communication unit 61, a display control unit 62, and an operation reception unit 63. These functional units are functions or means implemented by the CPU 501 illustrated in FIG. 3 executing commands included in one or more programs installed in the developer terminal 60. For example, the communication unit 61, the display control unit 62, and the operation reception unit 63 may be implemented by at least one of the web browsers and the JavaScript® programs. Alternatively, the communication unit 61, the display control unit 62, and the operation reception unit 63 may be implemented by a native application when the developer terminal 60 executes the native application.

The communication unit 61 transmits and receives various kinds of information to and from the information processing system 20. In the present embodiment, the communication unit 61 receives screen information regarding input of setting information from the information processing system 20. The communication unit 61 transmits the setting information and operation information for the developer terminal 60 to the information processing system 20. The communication unit 21 can also communicate with the generative AI system 50 and the application service 40.

The display control unit 62 interprets screen information of various screens to display screens on the display 506. The operation reception unit 63 receives various operations of the user on the various screens displayed on the display 506.

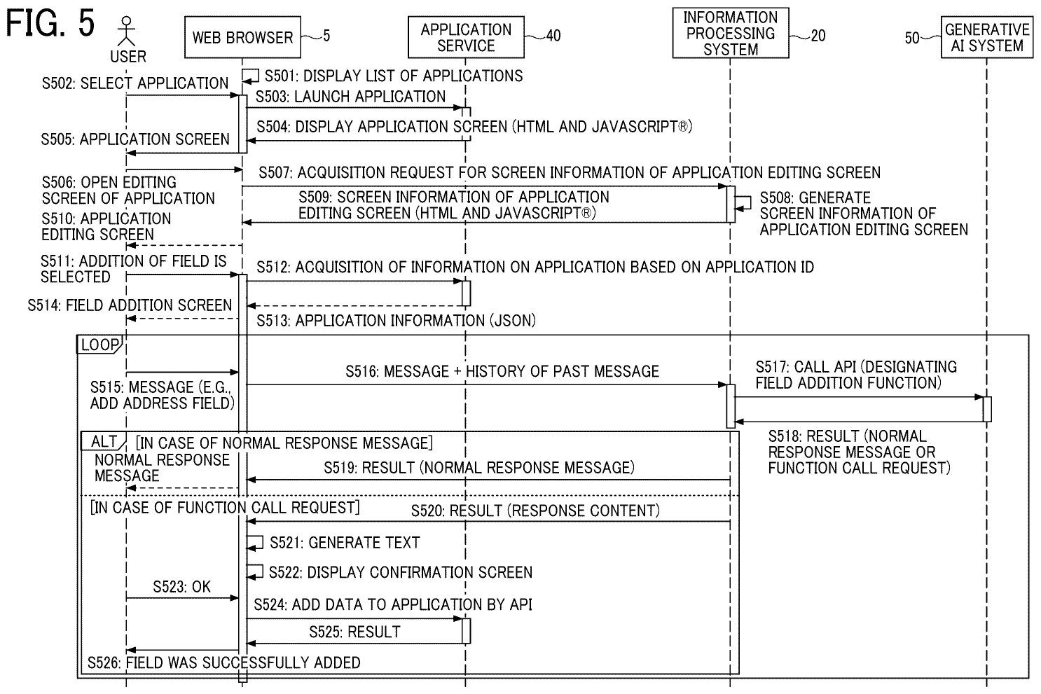

A description is given below of an operation of the application editing system 100 according to the present embodiment with reference to FIG. 5. FIG. 5 is a sequence diagram illustrating the operation of the application editing system 100 according to the first embodiment of the present disclosure.

In the following description, a case where a process of adding a field managed by an application is performed is described as an example of editing of the application.

In step S501, in the application editing system 100, the web browser 5 of the user terminal 10 displays an application list screen managed by the application service 40.

The application list screen according to the present embodiment may be displayed on the user terminal 10, for example, when an operation for displaying an application list is performed on the portal screen of the application service 40 displayed on the user terminal 10.

In step S502, the web browser 5 receives an operation of selecting an application to be edited on the application list screen.

In step S503, the web browser 5 requests the application service 40 to activate the selected application.

Specifically, the communication unit 11 of the web browser 5 connects to the URL of the application service 40. In the user terminal 10, since the application to be edited is selected, the communication unit 11 generates a hypertext transfer protocol (HTTP) request including the URL of the screen of the application selected as the application to be edited, and transmits the generated HTTP request to the application service 40. In the following description, the application screen may be referred to as an app screen. The application screen may be a home screen of the application that receives various operations for the application.

In step S504, when the application service 40 receives the HTTP request from the user terminal 10, the application service 40 transmits screen information of the application screen to the user terminal 10. Specifically, the application service 40 transmits the (e.g., HTML-based, JavaScript®-based, or CSS-based) screen information of the application screen to the user terminal 10.

In step S505, the web browser 5 receives the screen information of the application screen via the communication unit 11, and causes the display control unit 12 to display the application screen based on the screen information. In step S506, the operation reception unit 13 of the web browser 5 receives an operation of instructing the activation of the editing screen of the application from the application screen. In the following description, an application editing screen may be referred to as an application editing screen.

In step S507, the web browser 5 transmits an acquisition request for screen information of the application editing screen to the information processing system 20 via the communication unit 11. The acquisition request transmitted to the information processing system 20 may include an application identification (ID) that is identification information for identifying the application selected in step S502.

In step S508, the information processing system 20 generates the (e.g., HTML-based, JavaScript®-based, or CSS-based) screen information of the application editing screen.

A description is given below of generation of the screen information of the application editing screen by the information processing system 20. In the information processing system 20 according to the present embodiment, when the acquisition request for the screen information of the application editing screen is received, the editing program output unit 25 passes the editing process program for editing the selected application to the screen generation unit 22. In the editing program output unit 25, an editing process program written in JavaScript® may be prepared for each application managed by the application service 40.

The screen generation unit 22 includes the editing process program written in JavaScript® in the screen information of the application editing screen.

In step S509, the information processing system 20 transmits the screen information of the application editing screen to the user terminal 10 via the communication unit 21.

In step S510, the web browser 5 receives the screen information of the application editing screen via the communication unit 11, and causes the display control unit 12 to display the application editing screen based on the screen information. In step S511, the web browser 5 receives an operation of selecting the content of editing on the application editing screen via the operation reception unit 13. In this case, it is assumed that the addition of a field managed by the application is selected as the content of editing.

In step S512, when the addition of the field is selected as the content of editing, the communication unit 11 of the web browser 5 transmits the acquisition request for information on the application to the application service 40.

Specifically, the web browser 5 calls the second API 27 to transmit a request message for acquiring the information on the application to the application service 40. The acquisition request includes the application ID of the application selected as the application to be edited.

The information on the application is information written in a JSON format and includes fields managed by the application. In other words, the information on the application is information indicating an item of information managed in the application.

In step S513, the application service 40 receives the acquisition request and transmit the information on the application identified by the application ID to the user terminal 10. The information on the application transmitted from the application service 40 is written in the JSON format.

In step S514, the web browser 5 causes the display control unit 12 to display a field addition screen for adding a field.

In step S515, the web browser 5 receives an input of a chat message regarding the content of editing via the operation reception unit 13. In this case, the web browser 5 receives the chat message regarding the addition of the field. The input may be performed using a keyboard or by voice.

In step S516, the web browser 5 generates a request message including the chat message regarding the addition of the field, and transmits the generated request message to the information processing system 20 via the communication unit 11.

The request message transmitted from the user terminal 10 may include the application ID of the application to be edited, the information on the application, and the history of past conversations, in addition to the chat message.

The information processing system 20 may store the history of past conversations. In this case, the history of past conversations may be included in association with the application ID of the application to be edited, or may be included in association with a session ID of a conversation given each time a new conversation is held. When the information processing system 20 stores the history of past conversations, the communication unit 11 of the user terminal 10 may not include the history of the past conversations in the request message.

In step S517, when the information processing system 20 receives the request message from the user terminal 10, the information processing system 20 generates a request message to be transmitted to the generative AI system 50, and calls the first API 26 to transmit the generated request message to the generative AI system 50.

A description is given below of a process of the information processing system 20.

When the information processing system 20 receives the request message from the user terminal 10, the information processing system 20 passes the chat message included in the request message, the history of the past conversations, and the information on the application to the chat control unit 23.

The chat control unit 23 refers to the setting information storage unit 24 and determines a function corresponding to the content of editing indicated by the chat message. In this case, the chat message is a chat message instructing addition of a field. The chat control unit 23 refers to the setting information storage unit 24 and determines a field addition function that enables the generative AI system 50 to request the information processing system 20 to add a field.

The chat control unit 23 generates a request message including the chat message instructing addition of the field, the history of past conversations, information on the application, and the request message including the field addition function and calls the first API 26 to transmit the request message to the generative AI system 50. The request message transmitted to the generative AI system 50 may not include the history of the past conversations.

In step S518, the generative AI system 50 transmits a response message to the information processing system 20 in response to the request message transmitted from the information processing system 20. The response message may be a response message to the chat message or may include a function call request.

The following step S519 indicates a process when the response message from the generative AI system 50 is a response message. The following processing from step S520 to step S526 is processing performed when the response message from the generative AI system 50 is a function call request.

In step S519, when the chat control unit 23 of the information processing system 20 receives the response message, the communication unit 21 of the information processing system 20 transmits the response message to the web browser 5 of the user terminal 10, and the display control unit 12 of the web browser 5 displays the response message on the field addition screen.

The response message displayed in this case is the character string itself output from the generative AI system 50.

In step S520, when the chat control unit 23 receives the response message including the function call request, the communication unit 21 transmits the response message to the web browser 5 of the user terminal 10.

In step S521, the web browser 5 of the user terminal 10 receives the response message, and executes the editing process program that implements the application editing unit 14 to generate a text for confirming the content of the field to be added from the character string included in the response message.

In step S522, the web browser 5 causes the display control unit 12 to display a confirmation screen for confirming the content of the field to be added including the generated text. In step S523, the web browser 5 of the user terminal 10 receives an operation indicating that the user has confirmed the content of the field to be added, then in step S524, the application editing unit 14 requests the application service 40 to add the field of the application to be edited.

Specifically, the application editing unit 14 calls the second API 27 to transmit a request message for requesting the addition of the field included in the response message to the application to the application service 40. The request message for requesting addition of the field includes the application ID of the application selected as the application to be edited.

In step S525, the application service 40 adds the field in response to the request message received from the web browser 5, and transmits the result to the user terminal 10.

Specifically, when the application service 40 succeeds in adding the field, the application service 40 transmits a message indicating the success to the user terminal 10. When the application service 40 fails to add the field, the application service 40 transmits a message indicating the failure to the user terminal 10.

In step S526, when the web browser 5 of the user terminal 10 receives the message indicating the processing result of the addition of the field from the application service 40, the web browser 5 causes the display control unit 12 to display the received message.

In the application editing system 100 according to the present embodiment, the processing from step S515 to step S526 is repeated until the user's editing operation of the application is finished.

In FIG. 5, the process of the web browser 5 of the user terminal 10 acquiring the information on the application to be edited from the application service 40 is performed after the process of adding the field is selected in the web browser 5, but the present invention is not limited thereto. The process of acquiring the information on the application may be performed immediately after the application to be edited is selected. In other words, the process of acquiring the information on the application may be performed at any timing as long as the timing is after the application to be edited is selected and before the chat message is transmitted to the information processing system 20.

In the present embodiment, as a result, the user of the user terminal 10 can only input a chat message regarding the editing content to edit a desired application. As a result, according to the present embodiment, editing of an application can be supported.

### Second Embodiment

A description is given below of a second embodiment of the present disclosure with reference to the drawings. The second embodiment is different from the first embodiment in that the administrator of the application service 40 and the administrator of the information processing system 20 are different and two web browsers cooperate with each other in the user terminal 10. Thus, in the following description of the second embodiment, differences from the first embodiment are described. The components of the second embodiment having the same functional configurations as the components of the first embodiment are denoted by the same reference numerals used in the description of the first embodiment, and descriptions of the components similar to the first embodiment are omitted in the second embodiment.

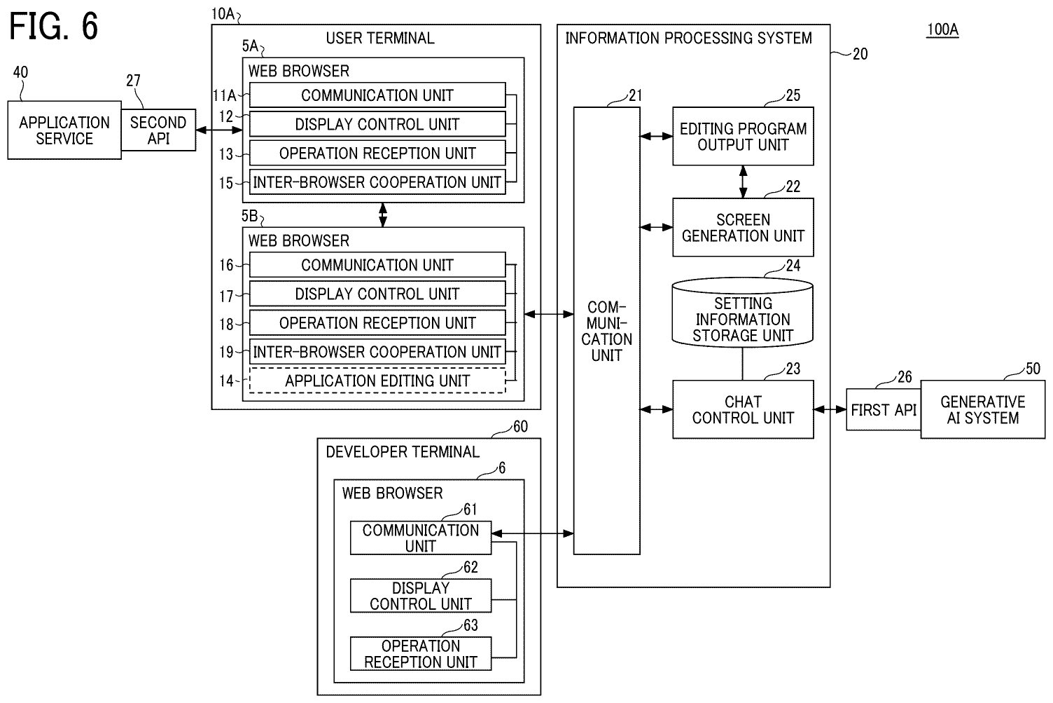

FIG. 6 is a diagram illustrating functions of an information processing system 20, a user terminal 10A, and a developer terminal 60 included in an application editing system 100A according to the second embodiment of the present disclosure.

The application editing system 100A according to the present embodiment includes the user terminal 10A, the information processing system 20, an application service 40, a generative AI system 50, and a developer terminal 60.

The user terminal 10A according to the present embodiment includes a web browser 5A and a web browser 5B. The web browser 5A according to the present embodiment is provided by a provider of the application service 40. The web browser 5B is provided by a provider of the information processing system 20. The web browser 5A is an example of a first web browser, and the web browser 5B is an example of a second web browser.

The web browser 5A includes a communication unit 11A, a display control unit 12, an operation reception unit 13, and an inter-browser cooperation unit 15.

The communication unit 11A transmits and receives information to and from the application services 40. The communication unit 11A receives screen information of an application list screen and information on an application to be edited from the application service 40.

The inter-browser cooperation unit 15 transmits and receives information between the web browser 5A and the web browser 5B. For example, the inter-browser cooperation unit 15 passes information on the application, which the communication unit 11A has received from the application service 40, to the web browser 5B.

The web browser 5B is a web browser that communicates with the generative AI system 50 via the information processing system 20.

The web browser 5B includes a communication unit 16, a display control unit 17, an operation reception unit 18, an inter-browser cooperation unit 19, and an application editing unit 14.

The communication unit 16 transmits and receives information to and from the information processing system 20. The communication unit 16 transmits, for example, a chat message input in the web browser 5B to the information processing system 20. The communication unit 16 receives, from the information processing system 20, a response message that the information processing system 20 has received from the generative AI system 50.

The inter-browser cooperation unit 19 transmits and receives information between the web browser 5A and the web browser 5B. For example, the inter-browser cooperation unit 19 passes a response message from the generative AI system 50, which is received by the communication unit 16 from the information processing system 20, to the web browser 5A.

In the present embodiment, as described above, a plurality of web browsers can be executed simultaneously on one user terminal 10. The inter-browser cooperation unit 15 can notify information from the web browser 5A to the web browser 5B. The inter-browser cooperation unit 19 can also notify information from the web browser 5B to the web browser 5A.

In the present embodiment, the inter-browser cooperation unit 19 of the user terminal 10 operates browsers in cooperation. As a result, when only one of the web browsers includes authentication information for a specific web site (e.g., the application service 40), the inter-browser cooperation unit 19 enables the other web browser to communicate with the specific web site in cooperation with the one web browser.

In other words, in the present embodiment, the web browser 5A and the web browser 5B communicate with each other, and thus the web browser 5B can communicate with the application service 40 in cooperation with the web browser 5A that includes the authentication information of the application service 40.

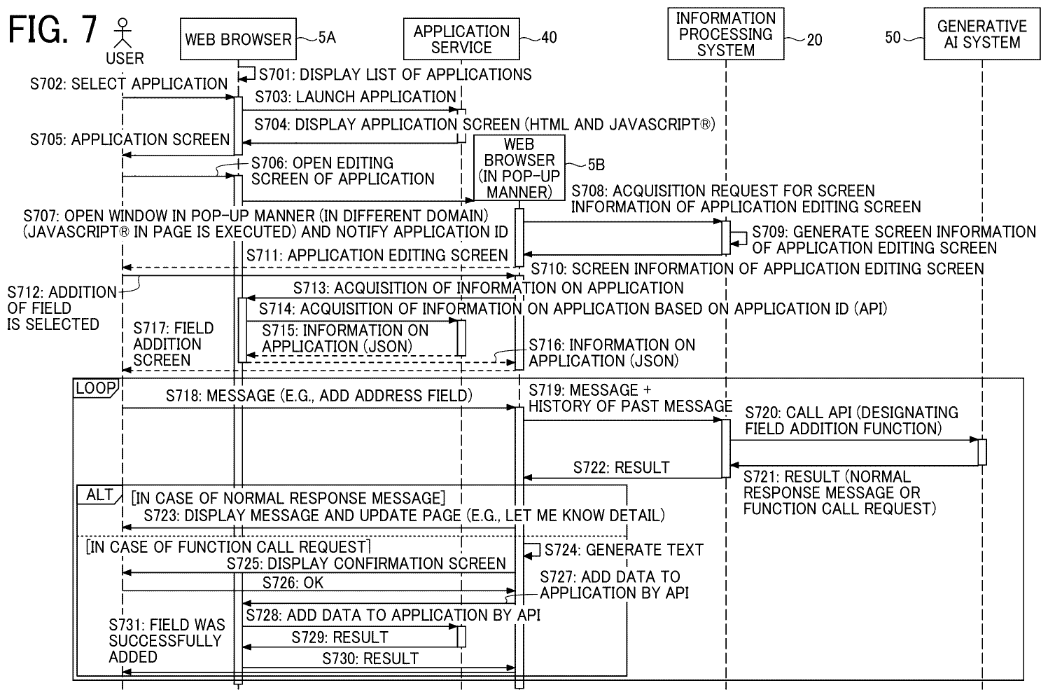

A description is given below of the operation of the application editing system 100A of the present embodiment with reference to FIG. 7. FIG. 7 is a sequence diagram illustrating the operation of an application editing system 100A according to the second embodiment of the present disclosure.

The processing from step S701 to step S706 in FIG. 7 is the same or substantially the same as the processing from step S501 to step S506 in FIG. 5 except that the web browser 5A performs the processing instead of the web browser 5, and redundant descriptions thereof are omitted below.

In step S707, when the web browser 5A of the user terminal 10 receives an operation to instruct activation of an editing screen of an application to be edited in step S706, the web browser 5B is activated via the inter-browser cooperation unit 15.

The inter-browser cooperation unit 15 processes to display the web browser 5B in a pop-up window on the user terminals 10. At this time, the inter-browser cooperation unit 15 notifies the web browser 5B of the URL of the application ID of the application selected as the application to be edited in step S706. The web browser 5B is activated by JavaScript® included in screen information of an application screen.

In step S708, the web browser 5B of the user terminal 10 transmits a request for acquiring screen information of an application edit screen to the information processing system 20 using the application ID notified from the web browser 5A. The acquisition request transmitted to the information processing system 20 includes the application ID.

In step S709, the information processing system 20 generates the (HTML-based, JavaScript®-based, or CSS-based) screen information of the application editing screen, and in step S710 the information processing system 20 transmits the screen information of the application editing screen to the web browser 5B of the user terminal 10. The web browser 5B receives the screen information of the application editing screen from the information processing system 20 via the communication unit 16. The screen information of the application editing screen includes an editing process program written in JavaScript®.

In step S711, the web browser 5B of the user terminal 10 causes the display control unit 17 to display the application editing screen.

In step S712, the operation reception unit 18 of the web browser 5B receives an operation of selecting the content of editing on the application editing screen. In this case, it is assumed that the addition of a field is selected as the content of editing.

In step S713, the web browser 5B transmits an acquisition request for information on the application specified by the application ID to the web browser 5A via the inter-browser cooperation unit 19.

In step S714, the web browser 5A receives the acquisition request, and the web browser 5A transmits an acquisition request for acquiring information on the application to the application service 40 via the communication unit 11A.

In step S715, the application service 40 receives the acquisition request and transmits information on the application specified by the application ID to the web browser 5A. The information on the application transmitted from the application service 40 is written in the JSON format.

In step S716, the inter-browser cooperation unit 15 of the web browser 5A notifies the web browser 5B of information on the application.

In step S717, the web browser 5B causes the display control unit 17 to display a field addition screen for adding the field.

In step S718, the web browser 5B receives an input of a chat message regarding the content of editing by the operation reception unit 18.

The processing from step S718 to step S726 in FIG. 7 is the same or substantially the same as the processing from step S515 to step S523 in FIG. 5 except that the web browser 5B performs the processing instead of the web browser 5, and redundant descriptions thereof are omitted below.

In step S726, when the web browser 5B receives an operation indicating that the added content has been confirmed, in step S727, the application editing unit 14 generates a request message for requesting the application service 40 to add the field of the application to be edited, and the inter-browser cooperation unit 19 notifies the web browser 5A of the request message.

In step S728, the web browser 5A receives the request message, the web browser 5A calls the second API 27 via the communication unit 11A to transmit a request message to the application service 40 to request the application service 40 to add the field included in the response message to the application.

In step S729, the application service 40 adds the field in response to the request message received from the web browser 5A, and transmits the result of processing to the web browser 5A.

In step S730, when the web browser 5A receives the processing result of the addition of the field from the application service 40, the inter-browser cooperation unit 15 notifies the web browser 5B of the processing result of the addition of the field.

In step S731, when the web browser 5B receives the processing result from the web browser 5A, the web browser 5A causes the display control unit 17 to display a screen indicating the processing result.

In the present embodiment, the processing from step S718 to step S731 are repeated until the user's editing operation of the application is finished.

In the present embodiment, as described above, the web browser 5A and the web browser 5B, which are provided by different providers, are cooperated in one user terminal 10.

Even when the web browser 5B does not include the authentication information for accessing the application service 40, the web browser 5A can communicate with the application service 40 via the web browser 5A that includes the authentication information for accessing the application service 40.

As a result, even when the provider of the application services 40 is different from the provider of the information processing system 20 and the domain of the web browser 5A is different from the domain of the web browser 5B, the function provided by the information processing system 20 can be cooperated with the application provided by the application service 40.

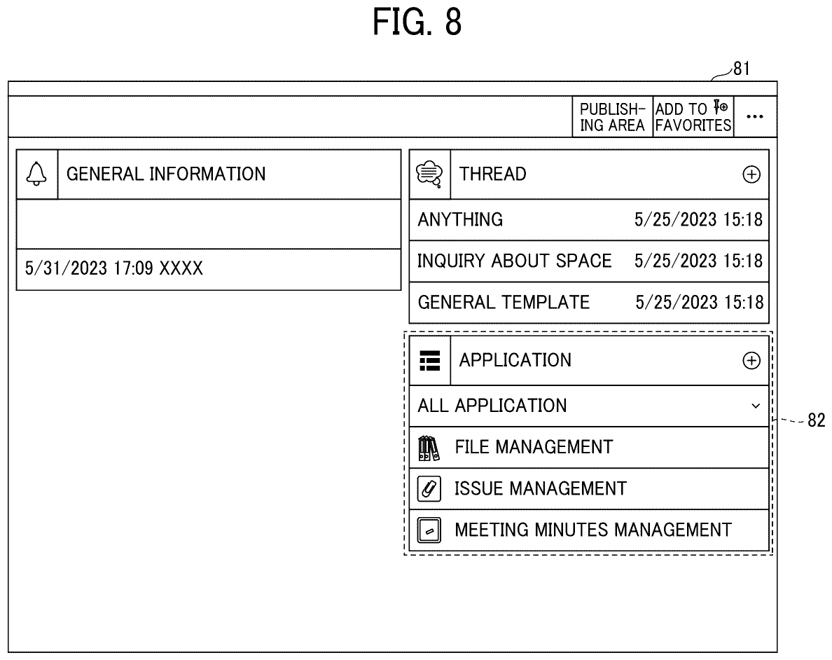

A description is given below of the operation of the application editing system 100A of the present embodiment in more detail with reference to FIGS. 8 to 13.

FIG. 8 is a first diagram illustrating a display of the user terminal 10. A screen 81 illustrated in FIG. 8 is an example of the application list screen displayed on the display by the web browser 5A in step S701 of FIG. 7.

The screen 81 includes a display area 82, and the display area 82 displays a list of applications allowed to be used by the user of the user terminal 10 among the applications provided by the application service 40.

When an application to be edited is selected in the display area 82, the web browser 5A according to the present embodiment acquires screen information of an application screen of the selected application from the application service 40 and displays the application screen on the display.

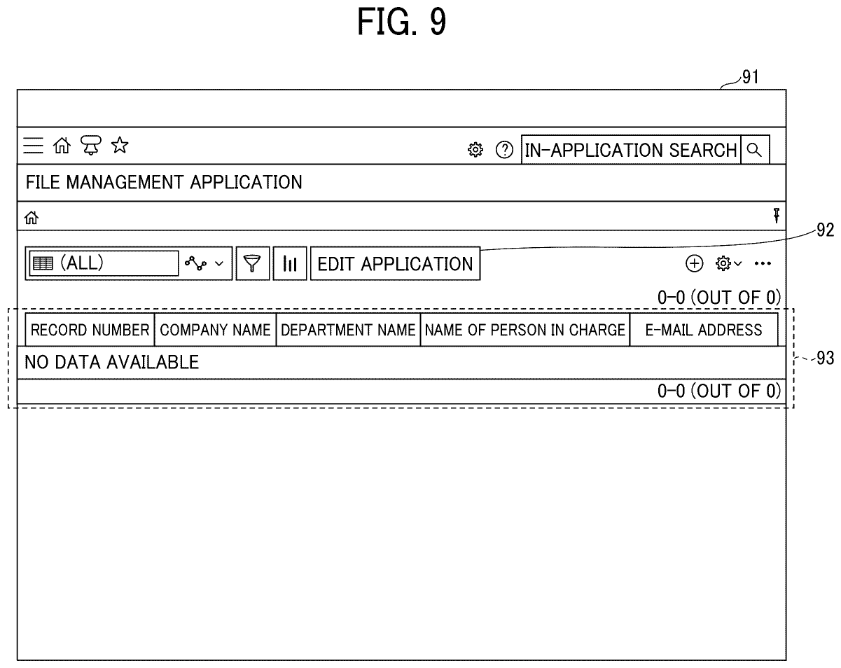

FIG. 9 is a second diagram illustrating a display of the user terminal 10. A screen 91 illustrated in FIG. 9 is an example of an application screen that the web browser 5A causes the display to display in step S705 of FIG. 7. A screen 91 illustrated in FIG. 9 is an application screen displayed when the “file management” application is selected as the application to be edited on the screen 81 illustrated in FIG. 8.

The screen 91 includes an operation button 92 and a display area 93. The operation button 92 is an operation button for instructing the start of an editing operation of the application. The display area 93 displays a list of fields managed by the “file management” application.

In the present embodiment, when the operation button 92 is operated, the web browser 5A is activated assuming that the editing operation of the application is started, and displays the web browser 5B in a pop-up window on the screen 91.

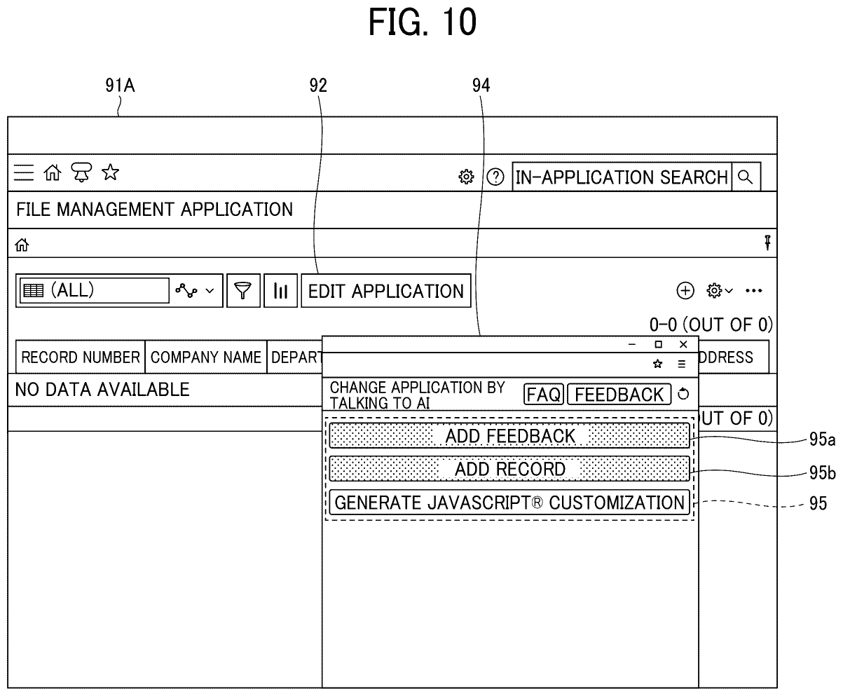

FIG. 10 is a third diagram illustrating a display of the user terminal 10. The screen 91A illustrated in FIG. 10 is an example of a screen displayed on the user terminal 10 in step S711 of FIG. 7. Specifically, the screen 91A is an example of a screen including an application editing screen displayed in a pop-up window by the web browser 5B.

The screen 91A includes a pop-up window 94 displayed by the web browser 5B. The pop-up window 94 includes a display area 95, and operation buttons 95a and 95b are displayed in the display area 95.

The operation buttons 95a and 95b are operation buttons for selecting the content of editing. The operation button 95a is an operation button for adding a field as the content of editing, and the operation button 95b is an operation button for deleting a field as the content of editing. The content of editing is not limited to the addition or deletion of the field, and an operation button for selecting the content of editing other than the addition or deletion of the field may be displayed in the display area 95. In the following description, it is assumed that the addition of the field is selected as the content of editing in FIG. 10.

In FIG. 10, the pop-up window 94 is displayed on the screen 91A in an overlapping manner. However, the pop-up window 94 may be displayed in a region different from the region where the screen 91A is displayed.

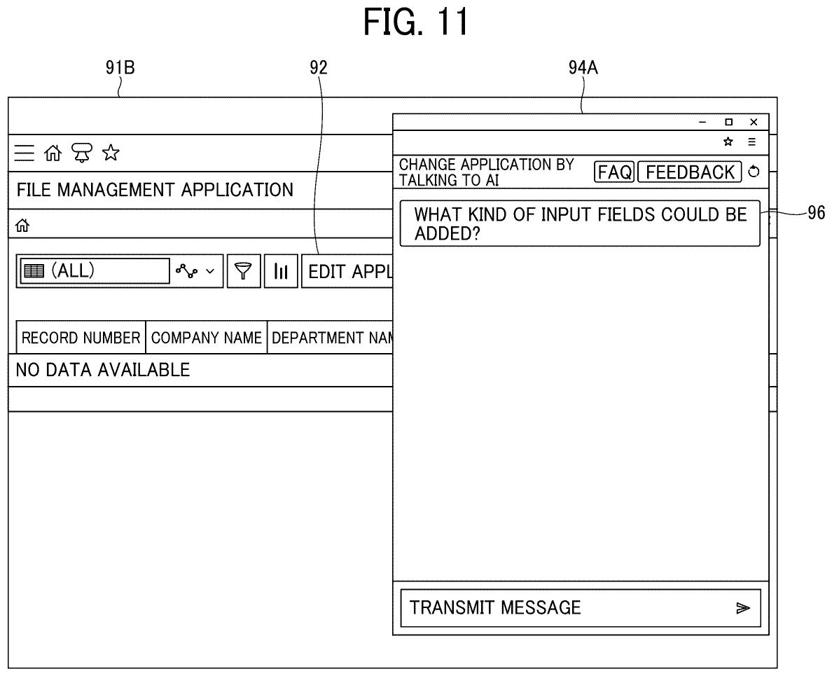

FIG. 11 is a fourth diagram illustrating a display of the user terminal 10. The screen 91B illustrated in FIG. 11 is an example of a screen displayed on the user terminal 10 in step S717 of FIG. 7. Specifically, the screen 91B is a screen including an additional screen of a field displayed in a pop-up window by the web browser 5B.

The screen 91B includes a pop-up window 94A. The pop-up window 94A is a chat screen for inputting a field to be added as a chat message. In FIG. 11, a message 96 for prompting the user to input a chat message is displayed in the pop-up window 94.

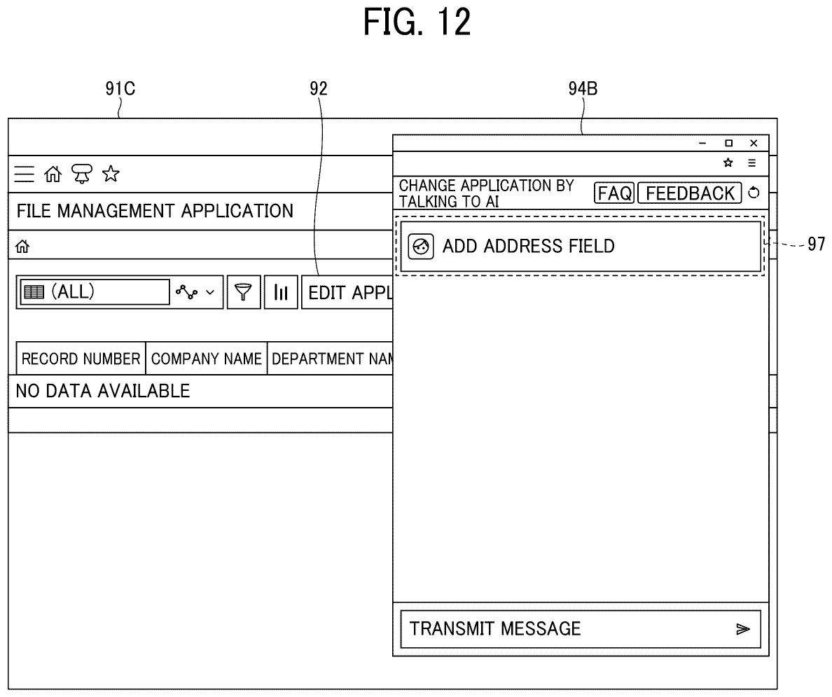

FIG. 12 is a fifth diagram illustrating a display of the user terminal 10. A screen 91C illustrated in FIG. 12 illustrates an example in which a chat message including the content of editing is input in step S718 of FIG. 7.

In the screen 91C, a chat message 97 including the content of editing is displayed in a pop-up window 94B. The chat message including the content of editing may be a chat message instructing a specific content of editing. In FIG. 12, the chat message 97 is a message instructing addition of an “address” field to the fields managed by the file management application.

In the present embodiment, when the chat message related to the content of editing is transmitted to the information processing system 20, the information processing system 20 transmits a request message to the generative AI system 50.

The request message transmitted to the generative AI system 50 includes the chat message instructing addition of the field, information on the file management application to be edited, and the field addition function, which are input in the pop-up window 94B.

A description is given below of the information on the application and the request message.

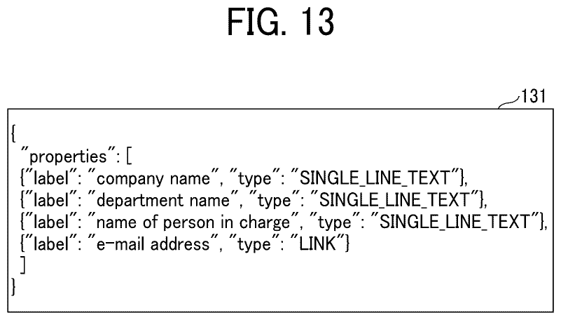

FIG. 13 is a diagram illustrating the information on the application to be edited. In the present embodiment, the application to be edited is written in the JSON format. In the present embodiment, the description in the JSON format is used as information on the application.

A description 131 illustrated in FIG. 13 represents the “file management application” in the JSON format. The description 131 indicates that the fields managed by the file management application are “company name,” “department name,” “name of person in charge,” and “e-mail address.”

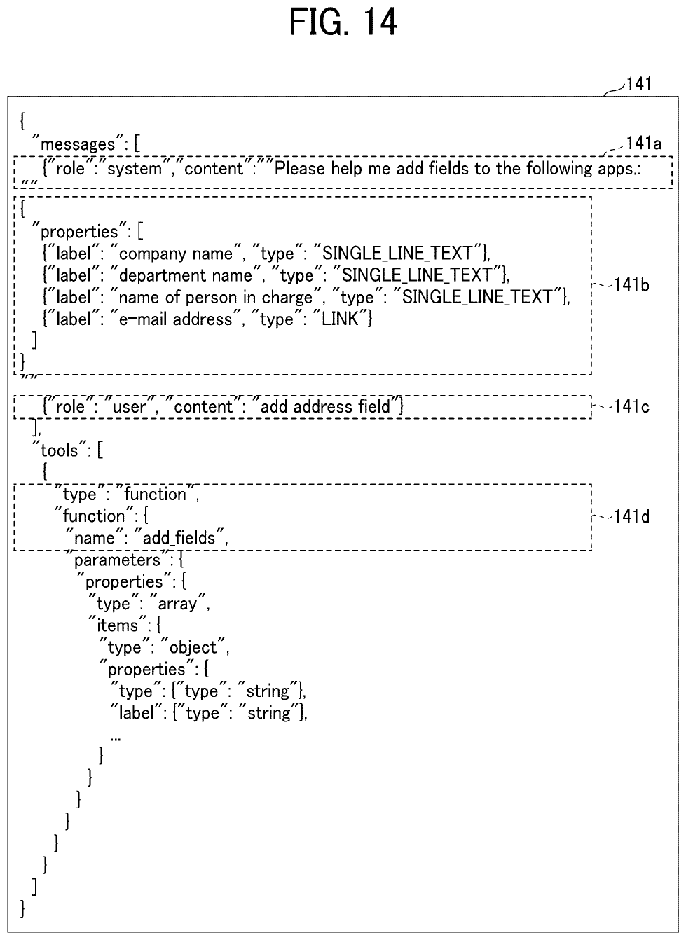

FIG. 14 is a diagram illustrating the request message transmitted from the information processing system 20 to the generative AI system 50.

A request message 141 illustrated in FIG. 14 is an example of the request message transmitted from the information processing system 20 to the generative AI system 50 in step S720 of FIG. 7.

The request message 141 includes descriptions 141a, 141b, 141c, 141d. The description 141a indicates a request to the generative AI system 50. The description 141a in FIG. 14 requests addition of the field to the application to be edited. In other words, the description 141a indicates that the addition of the field is selected as the content of editing.

The description 141b indicates the fields included in the file management application to be edited. In other words, the description 141b is the information on the application to be edited.

The description 141c is the chat message related to the content of editing input by the user. The description 141c indicates that the addition of the address field is instructed by the chat message.

The description 141d is a description for calling a function that defines the content of editing. In FIG. 14, the description 141d is a function that enables the generative AI system 50 to request the information processing system 20 to add the field to the file management application.

In the present embodiment, as described above, the request message is transmitted to the generative AI system 50, and the request message includes the chat message including the content of editing, the information related to the application specified by the application ID, and the information for calling the function defining the content of editing.

In the present embodiment, accordingly, specific content of editing for an existing application can be proposed to the generative AI system 50.

In FIG. 14, the request message in the case of adding a field has been described above. For example, when the content of editing is deletion of a field and the field to be deleted is specified in the chat message related to the content of editing, the function included in the description 141d is a function that enables the generative AI system 50 to request the information processing system 20 to delete the field in the file management application.

In the present embodiment, the function included in the description 141d may be a function called “edit,” and an argument may be “add.” As described above, by preparing the function “edit” and setting the argument to “delete” or “update,” various edits of the field can be performed.

The information processing system 20 according to the present embodiment transmits such a request message to the generative AI system 50, and the information processing system 20 receives a response message regarding the addition of the field from the generative AI system 50.

The generative AI system 50 may return a normal message or a message including a function call as the response message.

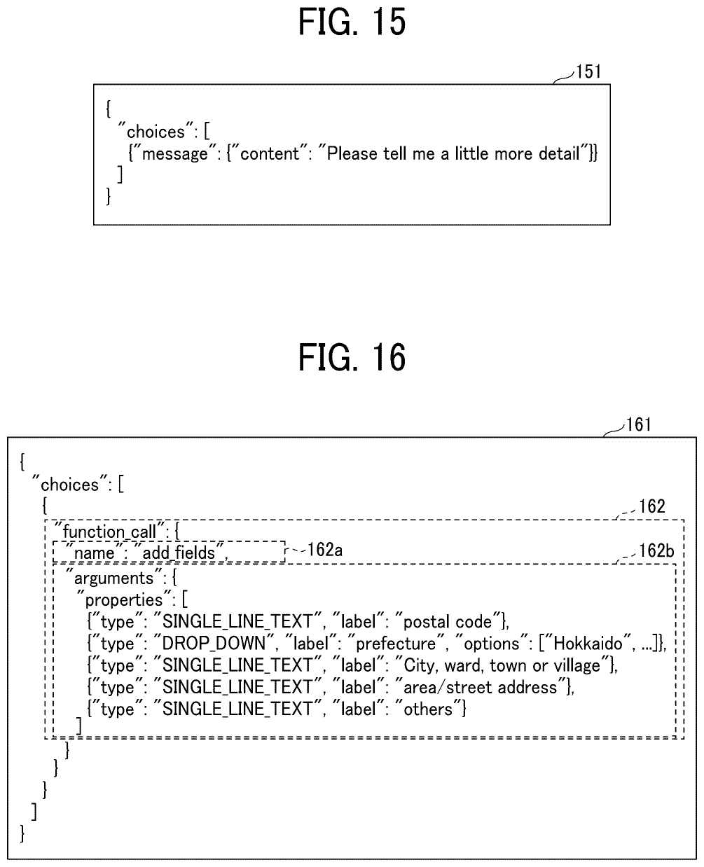

A description is given below of the response message from the generative AI system 50 with reference to FIGS. 15 and 16.

FIG. 15 is a first diagram of response message illustrating the response message from the generative AI system 50. A description 151 illustrated in FIG. 15 indicates that the response message from the generative AI system 50 is a normal message “Please tell me a little more detail.”

FIG. 16 is a second diagram of response message illustrating the response message from the generative AI system 50. A response message 161 illustrated in FIG. 16 includes a function call 162. The function call 162 corresponds to an application edit request. The function call request 162 includes a name 162a and arguments 162b. The name 162a is the name of the function defined in the description 141d of the request message 141.

The generative AI system 50 requests a call to a function with this name in response message 161. The arguments 162b are return values and are defined in the description 141d.

The response message 161 illustrated in FIG. 16 includes “postal code,” “Hokkaido,” “city, ward, town or village,” “area/street address,” and “others” as return values. The response message 161 requests addition of the fields such as “postal code,” “Hokkaido,” “city, ward, town or village,” “area/street address,” and “others.”

In the present embodiment, the information processing system 20 notifies the web browser 5B of the response message 161. In response to the notification, the web browser 5B generates a text including the character string (return value) included in the response message 161, and displays the generated text on the display as a response from the generative AI system 50.

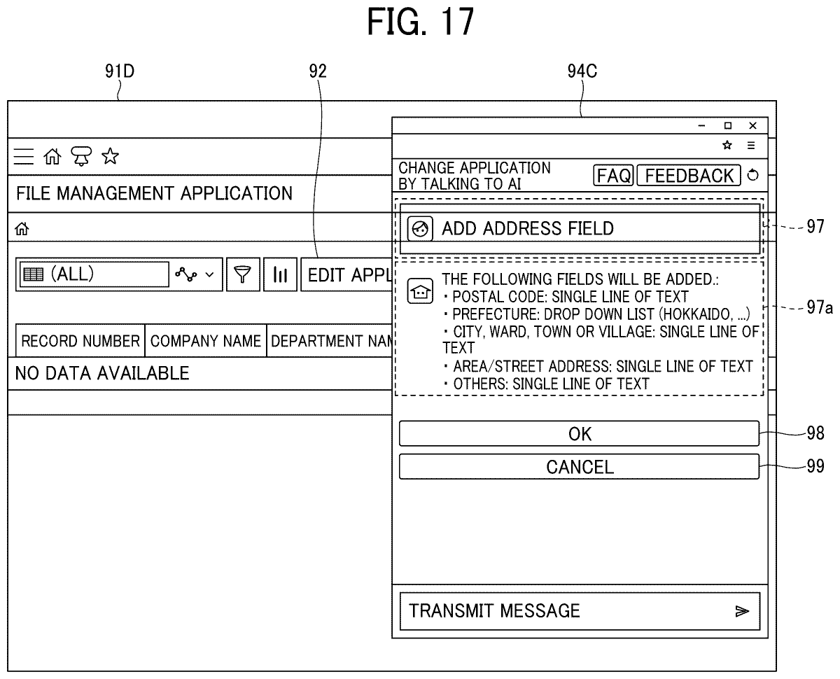

FIG. 17 is a sixth diagram illustrating a display of the user terminal 10. A screen 91D illustrated in FIG. 17 is an example of a confirmation screen for confirming the content of the fields added by the web browser 5B in step S725 of FIG. 7.

In the screen 91D, a chat message 97 instructing addition of the “address” field and a text 97a generated from the response message transmitted from the generative AI system 50 are displayed in a pop-up window 94C. Operation buttons 98 and 99 are displayed in the pop-up window 94C.

The text 97a displays a list of fields added by the generative AI system 50. The operation button 98 is operated when the user of the user terminal 10 permits the addition of the fields indicated by the text 97a. The operation button 99 is operated when the user of the user terminal 10 does not permit the addition of the fields indicated by the text 97a.

In the present embodiment, when the operation button 98 is operated, the fields indicated by the text 97a are added to the file management application.

In the present embodiment, as described above, the user terminal 10 is caused to confirm the content of editing proposed by the generative AI system 50. As a result, according to the present embodiment, the editing not intended by the user can be prevented from being automatically performed.

In the present embodiment, when the operation button 98 is operated in the pop-up window 94C, the web browser 5B transmits a request message for requesting addition of the fields to the file management application to the application services 40 via the web browser 5A.

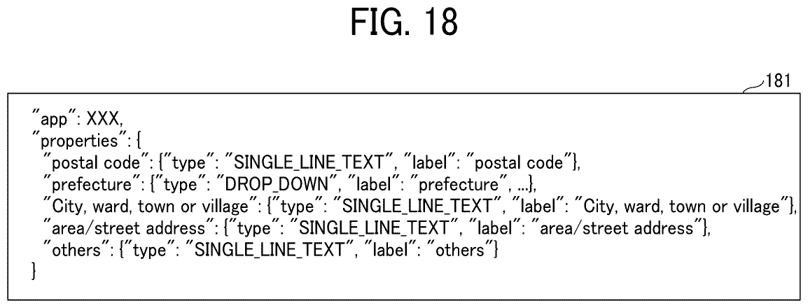

FIG. 18 is a diagram illustrating the request message transmitted from the web browser 5B to the application service 40.

The request message 181 illustrated in FIG. 18 is, for example, transmitted from the web browser 5B to the application service 40 via the web browser 5A in step S727 of FIG. 7.

The request message 181 describes a request for adding the fields included in the response message 161 transmitted from the generative AI system 50 to the information processing system 20.

In the present embodiment, when the addition of the fields to the file management application is finished, the application service 40 notifies the web browser 5B of the processing result via the web browser 5 A, and the web browser 5B displays the processing result.

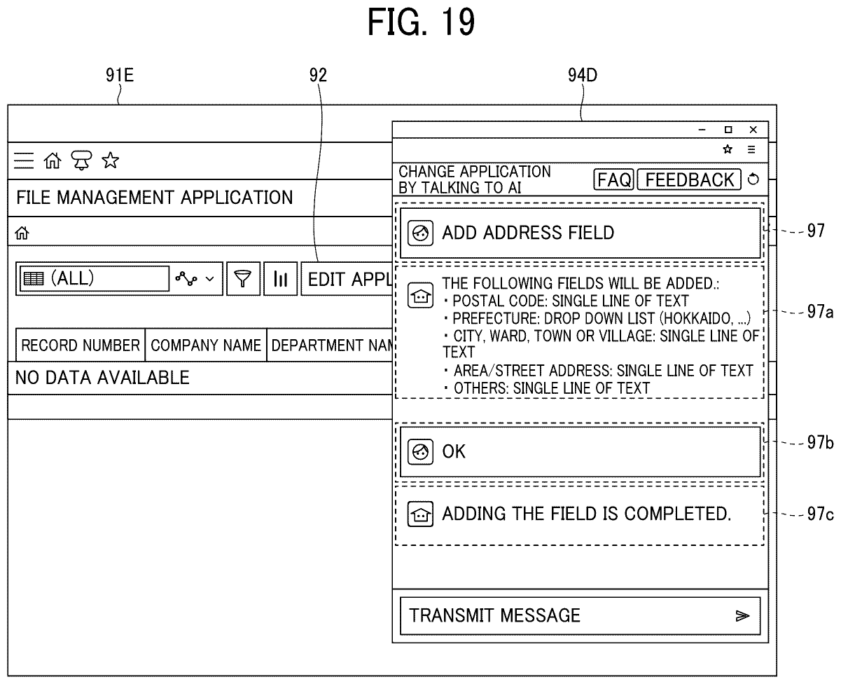

FIG. 19 is a seventh diagram illustrating a display of the user terminal 10. A screen 91E illustrated in FIG. 19 is an example of the screen indicating the processing result, which is displayed by the web browser 5B in step S731 of FIG. 7.

In FIG. 19, a pop-up window 94D displays a chat message 97 and text 97a, 97b, and 97c.

The text 97a indicates the result of confirmation by the user on the content indicated by the text 97a. In the present embodiment, when the operation button 98 displayed in the pop-up window 94C is operated, the text 97b may be automatically displayed in the pop-up window 94D.

The text 97c indicates the result of the field addition processing performed by the application service 40. In FIG. 19, the text 97c indicates that the processing of the addition of the field in the application service 40 is finished.

In the present embodiment, as described above, the user can simply input a chat message instructing the content of editing in the pop-up window 94 to edit the application to be edited.

When the user of the user terminal 10 wants to add another field, the user may input a chat message indicating the field to be added again below the text 97c in the pop-up window 94D.

For example, when a chat message “add phone number” is input below the text 97c in the pop-up window 97D, the chat message is transmitted from the web browser 5B to the information processing system 20.

Then, the information processing system 20 transmits a request message including the chat message to the generative AI system 50.

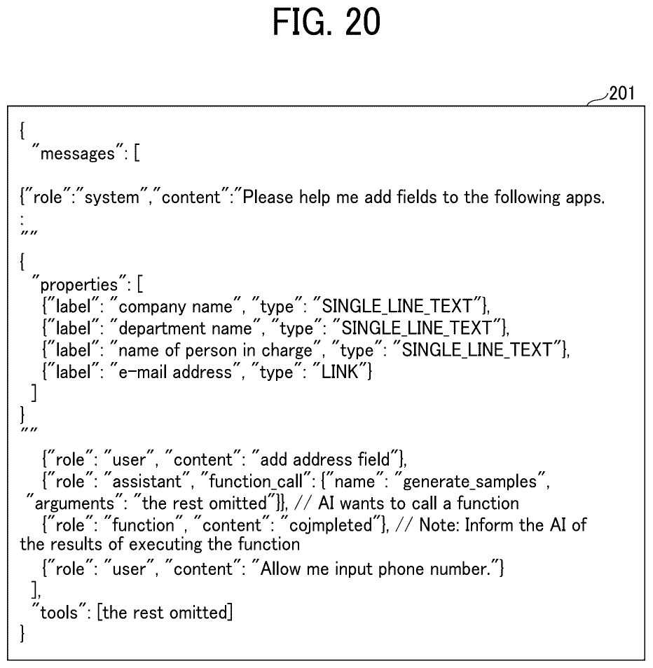

FIG. 20 is a diagram illustrating another request message transmitted from the information processing system 20 to the generative AI system 50.

When the chat message “add phone number” is further input to the pop-up window 94D illustrated in FIG. 19, the information processing system 20 generates a request message 201 including the chat message and transmits the request message 201 to the generative AI system 50.

In the present embodiment, as a result, a field can be repeatedly added until the user ends the operation of adding the field.

The apparatuses or devices described in the embodiments described above are merely one example of multiple computing environments that implement one or more embodiments of the disclosure.

In some embodiments, an information processing apparatus configuring the information processing system 20 includes multiple computing devices, such as a server cluster. The multiple computing devices are configured to communicate with one another through any type of communication link including, for example, a network or a shared memory, and perform the processes disclosed in the present specification. In substantially the same manner, for example, the information processing apparatus configuring the information processing system 20 includes such multiple computing devices configured to communicate with one another.

Further, the information processing apparatus such as the information processing system 20 can be configured to share the disclosed processing steps in various combinations. For example, a process performed by a given unit may be performed by the information processing system 20. In substantially the same manner, the function of a predetermined unit can be performed by the information processing system 20. In the information processing system 20, the elements included in the information processing system 20 may be combined into one server apparatus or may be divided into a plurality of apparatuses.

The information processing apparatus may be, for example, a projector, an interactive whiteboard (IWB; an electronic whiteboard having a blackboard function to enable mutual communication), an output device such as digital signage, a head-up display (HUD) device, an industrial machine, an image-capturing device, a sound collecting device, a medical device, a networked home appliance, an automobile (connected car), a laptop PC, a mobile phone, a smartphone, a tablet communication terminal, a game console, a personal digital assistant (PDA), a digital camera, a wearable PC, or a desktop PC.

A description is given below of some aspects of the present disclosure.

### Aspect 1

An information processing apparatus that communicates with a terminal apparatus and a generative artificial intelligence (AI) system via a network includes a communication unit and a chat control unit. The communication unit receives, from the terminal apparatus, an acquisition request for acquiring screen information of an editing screen of an application. The acquisition request includes identification information of the application. The communication unit transmits, to the terminal apparatus, the screen information including a program for editing the application in response to a response message from the generative AI system. When the communication unit receives, from the terminal apparatus, a chat message including an editing content input to the editing screen displayed on the terminal apparatus, the chat control unit transmits the chat message, information on the application specified by the identification information, and information to call a function defining the editing content to the generative AI system, and the chat control unit receives a response message including the call of the function defining the editing content from the generative AI system. The communication unit further transmits the response message including the call of the function defining the editing content, which is received by the chat control unit, to the terminal apparatus. The communication unit causes the terminal apparatus to execute an editing process based on the function defining the editing content.

### Aspect 2

In the information processing apparatus according to Aspect 1, the terminal apparatus includes a first web browser that communicates with an application service that provides the application, and a second web browser that communicates with the first web browser. The communication unit receives, from the second web browser, the acquisition request for the screen information transmitted from the first web browser to the second web browser in response to an operation on the first web browser, and transmits the screen information to the second web browser. The chat control unit transmits the chat message input to the editing screen displayed by the second web browser to the generative AI system. The communication unit further transmits the response message received by the chat control unit from the generative AI system to the second web browser.

### Aspect 3

In the information processing apparatus according to Aspect 2, the information related to the application is information acquired from the application service by the first web browser. The communication unit receives the information related to the application via the second web browser.

### Aspect 4

In the information processing apparatus according to Aspect 2 or Aspect 3, the communication unit receives the information on the application from the second web browser together with the chat message transmitted from the second web browser.

### Aspect 5

In the information processing apparatus according to any one of Aspects 1 to 4, when the response message from the generative AI system includes a request to call the function defining the editing content, the program for editing the application causes the terminal apparatus to execute the editing process of the application in response to the request to call the function.

### Aspect 6

In the information processing apparatus according to any one of Aspects 1 to 5, the chat control unit transmits information indicating a history of past conversations to the generative AI system.

### Aspect 7

In the information processing apparatus according to any one of Aspects 1 to 6, editing the application includes addition, deletion, and update of a field managed by the application.

### Aspect 8

An application editing system communicates with a terminal apparatus, a generative AI system, and an information processing apparatus via a network. The information processing apparatus includes a communication unit and a chat control unit. The communication unit receives, from the terminal apparatus, an acquisition request for acquiring screen information of an editing screen of an application. The acquisition request includes identification information of the application. The communication unit transmits, to the terminal apparatus, the screen information including a program for editing the application in response to a response message from the generative AI system. When the communication unit receives, from the terminal apparatus, a chat message including an editing content input to the editing screen displayed on the terminal apparatus, the chat control unit transmits the chat message, information on the application specified by the identification information, and information to call a function defining the editing content to the generative AI system, and the chat control unit receives a response message including the call of the function defining the editing content from the generative AI system. The communication unit further transmits the response message including the call of the function defining the editing content, which is received by the chat control unit, to the terminal apparatus. The terminal apparatus includes a web browser. When the response message from the generative AI system includes a request to call the function defining the editing content, the web browser causes the terminal apparatus to execute the program for editing the application.

### Aspect 9

A program, when executed by a computer, causes an information processing apparatus, which communicates with a terminal apparatus and a generative AI system via a network, to perform a method for editing an application. The method includes: receiving, from the terminal apparatus, an acquisition request for acquiring screen information of an editing screen of the application, acquisition request including identification information of the application; transmitting, to the terminal apparatus, the screen information including a program for editing the application in response to a response message from the generative AI system; when the communication unit receives, from the terminal apparatus, a chat message including an editing content input to the editing screen displayed on the terminal apparatus, transmitting the chat message, information on the application specified by the identification information, and information to call a function defining the editing content to the generative AI system; receiving a response message including the call of the function defining the editing content from the generative AI system; transmitting the response message, which is received from the generative AI system, including the call of the function defining the editing content to the terminal apparatus; and causing the terminal apparatus to execute an editing process based on the function defining the editing content.

### Aspect 10

A method causes an information processing apparatus, which communicates with a terminal apparatus and a generative AI system via a network, to perform a method for editing an application. The method includes: receiving, from the terminal apparatus, an acquisition request for acquiring screen information of an editing screen of the application, acquisition request including identification information of the application; transmitting, to the terminal apparatus, the screen information including a program for editing the application in response to a response message from the generative AI system; when the communication unit receives, from the terminal apparatus, a chat message including an editing content input to the editing screen displayed on the terminal apparatus, transmitting the chat message, information on the application specified by the identification information, and information to call a function defining the editing content to the generative AI system; receiving a response message including the call of the function defining the editing content from the generative AI system; transmitting the response message, which is received from the generative AI system, including the call of the function defining the editing content to the terminal apparatus; and causing the terminal apparatus to execute an editing process based on the function defining the editing content.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. The elements of the above-described embodiments can be modified without departing from the gist of the present invention and can be appropriately determined according to the application form.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc read-only memory (CD-ROM) or a digital versatile disk (DVD), and/or the memory of an FPGA or ASIC.

1. An information processing apparatus communicably connected with a terminal apparatus and a generative artificial intelligence (AI) system via a network, the information processing apparatus comprising:
processing circuitry configured to:
receive, from the terminal apparatus, an acquisition request for acquiring screen information of an editing screen of an application, the acquisition request including identification information of the application;
transmit, to the terminal apparatus, the screen information including a program for editing the application in response to a response message from the generative AI system;
in response to receiving, from the terminal apparatus, a chat message including an editing content input to the editing screen displayed on the terminal apparatus based on the screen information, transmit to the generative AI system the chat message, information on the application specified by the identification information, and information used for calling a function defining the editing content;
receive a response message including the call of the function defining the editing content from the generative AI system;
transmit the response message including the call of the function defining the editing content to the terminal apparatus; and
cause the terminal apparatus to execute an editing process based on the function defining the editing content.

2. The information processing apparatus according to claim 1, wherein
the terminal apparatus includes terminal circuitry configured to execute a first web browser and a second web browser, the first web browser communicating with an application service that provides the application, and the second web browser communicating with the first web browser,
the processing circuitry is configured to:
receive, from the second web browser, the acquisition request for the screen information transmitted from the first web browser to the second web browser in response to an operation on the first web browser;
transmit the screen information to the second web browser;
transmit the chat message input to the editing screen displayed by the second web browser to the generative AI system; and
transmit the response message received from the generative AI system to the second web browser.

3. The information processing apparatus according to claim 2,
wherein the information related to the application is information acquired from the application service by the first web browser, and
wherein the processing circuitry is configured to receive the information related to the application via the second web browser.

4. The information processing apparatus according to claim 2,
wherein the processing circuitry is configured to receive the information on the application from the second web browser together with the chat message transmitted from the second web browser.

5. The information processing apparatus according to claim 1,
wherein the terminal apparatus includes terminal circuitry,
wherein when the response message includes the call of the function defining the editing content, the terminal circuitry executes the program for editing the application to perform the editing process of the application in response to the request to call the function.

6. The information processing apparatus according to claim 1,
wherein the processing circuitry is configured to transmit information indicating a history of past conversations to the generative AI system.

7. The information processing apparatus according to claim 1, wherein the editing process includes addition, deletion, and update of a field managed by the application.

8. An application editing system comprising:
a terminal apparatus; and
an information processing apparatus communicably connected with the terminal apparatus and a generative AI system via a network,
the information processing apparatus including processing circuitry configured to:
receive, from the terminal apparatus, an acquisition request for acquiring screen information of an editing screen of an application, the acquisition request including identification information of the application;
transmit, to the terminal apparatus, the screen information including a program for editing the application in response to a response message from the generative AI system;
in response to receiving, from the terminal apparatus, a chat message including an editing content input to the editing screen displayed on the terminal apparatus based on the screen information, transmit to the generative AI system the chat message, information on the application specified by the identification information, and information used for calling a function defining the editing content;
receive a response message including the call of the function defining the editing content from the generative AI system; and
transmit the response message including the call of the function defining the editing content to the terminal apparatus,
the terminal apparatus including
terminal circuitry configured to execute a web browser, and
when the response message from the generative AI system includes a request to call the function defining the editing content, the web browser executes the program for editing the application.

9. The application editing system according to claim 8, wherein
the web browser includes a first web browser that communicates with an application service providing the application, and
a second web browser that communicates with the first web browser,
the processing circuitry is configured to:
receive, from the second web browser, the acquisition request for the screen information transmitted from the first web browser to the second web browser in response to an operation on the first web browser;
transmit the screen information to the second web browser;
transmit the chat message input to the editing screen displayed by the second web browser to the generative AI system; and
transmit the response message received from the generative AI system to the second web browser.

10. The application editing system according to claim 9,
wherein the information related to the application is information acquired from the application service by the first web browser, and
wherein the processing circuitry is configured to receive the information related to the application via the second web browser.

11. The application editing system according to claim 9,
wherein the processing circuitry is configured to receive the information on the application from the second web browser together with the chat message transmitted from the second web browser.

12. The application editing system according to claim 8,
wherein when the response message includes a request to call the function defining the editing content, the terminal circuitry executes the program for editing the application to perform the editing process of the application in response to the request to call the function.

13. The application editing system according to claim 8,
wherein the processing circuitry is configured to transmit information indicating a history of past conversations to the generative AI system.

14. The application editing system according to claim 8, wherein the editing process includes addition, deletion, and update of a field managed by the application.

15. An information processing method, executed by an information processing apparatus communicably connected with a terminal apparatus and a generative AI system via a network, the method comprising:
receiving, from the terminal apparatus, an acquisition request for acquiring screen information of an editing screen of the application, the acquisition request including identification information of the application;
transmitting, to the terminal apparatus, the screen information including a program for editing the application in response to a response message from the generative AI system;
in response to receiving, from the terminal apparatus, a chat message including an editing content input to the editing screen displayed on the terminal apparatus based on the screen information, transmitting to the generative AI system the chat message, information on the application specified by the identification information, and information used for calling a function defining the editing content;
receiving a response message including the call of the function defining the editing content from the generative AI system;
transmitting the response message received from the generative AI system to the terminal apparatus, the response message including the call of the function defining the editing content; and
causing the terminal apparatus to execute an editing process based on the function defining the editing content.
